(19) United States
(12) Patent Application Publication
(10) Pub. No.: US 2010/0259205 A1
(43) Pub. Date: Oct. 14, 2010

(54) SYSTEM FOR POWERING AN ELECTRIC MACHINE

(75) Inventors: Yann Le Pecheur, Ivry le Temple (FR); Mickael Tihy, Saint Etienne (FR)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES DE CONTROLE MOTEUR, Cergy Pontoise Cedex (FR)

(21) Appl. No.: 12/680,870

(22) PCT Filed: Sep. 30, 2008
(86) PCT No.: PCT/FR08/01361

§ 371 Date: Jun. 18, 2010

(30) Foreign Application Priority Data
Oct. 1, 2007 (FR) 0706878

(51) Int. Cl. H02P 27/00

(52) U.S. Cl. 318/400.3

(57) ABSTRACT

The invention relates to a system (100) for powering an electric machine (M). One particularly interesting application of the present invention is to the field of powering electric motors used in automobiles. The system (100) comprises a voltage source (102), an electronic circuit (108) for supplying the electric machine (M), a first switch (101), wherein the voltage source (102) powers the electronic circuit (108) when the first switch (101) is in a closed position, at least one capacitor (104, 105) mounted in parallel on the voltage source (102) when the first switch (101) is in the closed position, and a precharge circuit (114) for the capacitor (104, 105). The system further includes a second switch (+APC), wherein the precharge circuit (114) is connected to the voltage source (102) when the second switch (+APC) is closed, and the first switch (101) is controlled so as to be closed after the precharge of the capacitor (104, 105).

The present invention relates to a system for supplying power to an electric machine. A particularly valuable application of the invention lies in the field of supplying power to electric motors used in motor vehicles.

Usually, a system for supplying power to an electric machine such as an electric motor used in a motor vehicle comprises a power circuit designed to transmit the voltage from the vehicle battery to an electronic circuit board managing the power supply of said motor.

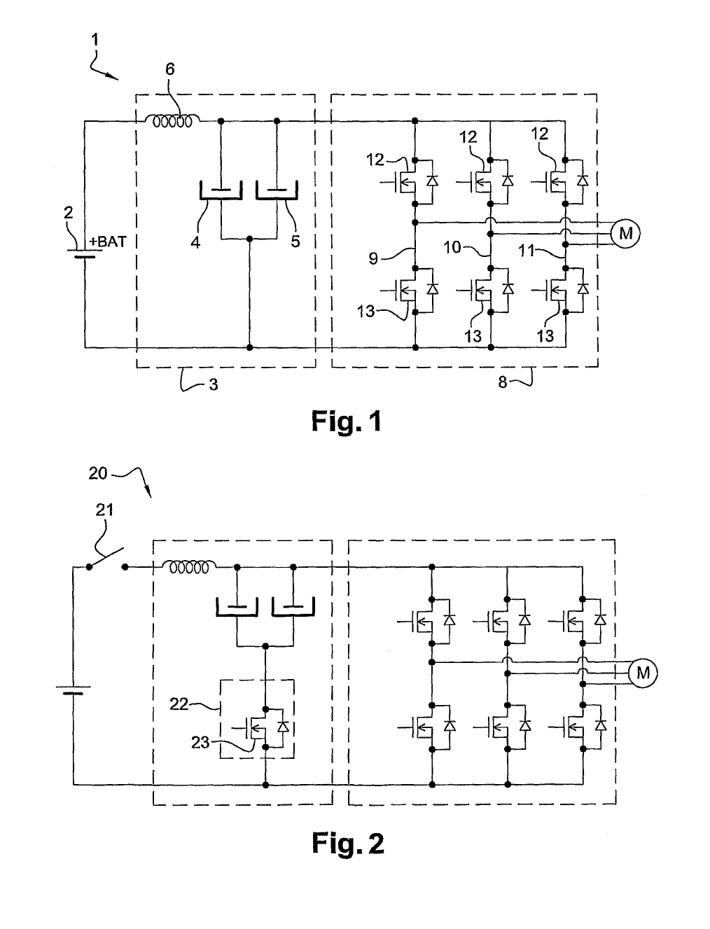

An example of such a power-supply system 1 is shown schematically in FIG. 1. The system comprises:
a voltage source 2 formed by the vehicle battery,
a power circuit 3
an electronic power-supply circuit 8 designed to supply power to a motor M.

The power circuit 3 comprises:
two capacitors 4 and 5 mounted in parallel,
an inductor 6 connected between the positive terminal +Bat of the battery 2 and a first common terminal of the two capacitors 4 and 5.

The function of the power circuit 3 is to transmit the voltage from the battery 2 to the electronic power-supply circuit 8. The power circuit consists, for example, of several copper busbars, not shown.

In the case of a brushless motor M such as that used in an electric power steering system, the electronic power-supply circuit 8 consists of a chopping power-supply circuit comprising three bridge arms 9, 10 and 11 each comprising two transistors 12 and 13 mounted in series, each transistor being furnished with an anti-parallel diode (the antiparallel diode is often present in manufacture on field-effect transistors of the MOSFET type). Each of the three stator windings of the motor M is therefore supplied by one of the bridges 9, 10 and 11. For the purposes of clarity, the control circuits of the transistors have not been shown.

The chopping of the voltage caused by the electronic power-supply circuit 8 can disrupt the whole onboard network and the voltage of the battery 2. The filter formed by the inductor 6 and the capacitors 4 and 5 is designed to stabilize the voltage of the battery 2. The filter makes it possible, to some extent, to smooth the inverted voltage. The value of the filtering capacity is usually high: that is why, as in the example proposed here, two discrete capacitors 4 and 5 mounted in parallel are often used, these capacitors 4 and 5 preferably being electrochemical capacitors, the common positive pole of which is connected to the inductor 6.

However, such a configuration poses a problem because the battery is always connected both to the power circuit and to the electronic power-supply circuit. This permanent connection may involve leakage currents capable of causing undesired heating.

Therefore, certain manufacturers require the presence of a switch making it possible to disconnect the power supply from the circuits. An example of a power-supply system 20 having such a configuration is shown in FIG. 2.

The system 20 is identical to the system 1 of FIG. 1 except that it comprises a switch 21 making it possible to selectively connect the battery to the power circuit and to the electronic power-supply circuit.

Such a switch 21 requires the presence of a precharge circuit 22 for precharging the capacitors, said precharge circuit belonging to the power circuit; the precharge circuit is designed to prevent the inrush currents that could arise if the switch 21 on initially discharged capacitors closes. The inrush currents, that may reach 100 A (or even 200 A) can damage the battery, the various connectors, the relay contact, the chemical capacitors and even the fuses.

The precharge circuit 22 comprises, for example, a power field-effect transistor 23 of the MOSFET type: this transistor is, for example, controlled with increasingly frequent pulses until it closes completely. Such a precharge circuit makes it possible to ensure a progressive charging of the electrochemical capacitors, the transistor 23 playing the role of a resistive load and forming, with the capacitors, an RC circuit: once the capacitors are charged, the transistor is kept in the closed position.

However, applying the configuration as shown in FIG. 2 also poses certain problems.

Thus, the major drawback of this configuration lies in the modification of the power circuit and more particularly in the addition of an impedance (for example the power MOSFET transistor) in the filter contained in this power circuit.

The presence of this impedance requires new connections, reduces the overall efficiency of the circuit and can have consequences in terms of EMC (Electro-Magnetic Compatibility) because the filter was designed to operate satisfactorily (with no added impedance) in its electromagnetic environment without itself causing electromagnetic disturbance.

Moreover, the addition of this impedance causes a not inconsiderable extra cost because it requires the use of a component of the transistor type operating at high power and having a low impedance in the on state.

In this context, the object of the present invention is to provide a system for supplying power to an electric machine comprising a precharge circuit, said system making it possible to dispense with the aforementioned EMC problems and having powerful electric efficiency and a relatively small extra cost relative to systems with no precharge circuit.

For this purpose, the invention proposes a system for supplying power to an electric machine comprising:
a voltage source,
an electronic circuit for supplying power to said electric machine,
a first switch, said voltage source supplying power to said electronic circuit when said first switch is in the closed position,
at least one capacitor mounted in parallel on said voltage source when said first switch is in the closed position,
a circuit for precharging said capacitor, said system being characterized in that it comprises a second switch, said precharge circuit being connected to said voltage source when said second switch is closed and said first switch being controlled to close after the precharging of said capacitor.

A precharge circuit is a circuit allowing the capacitor to charge more slowly than in the absence of a precharge circuit and thus prevent too great an inrush current from the discharged capacitor when the first switch closes.

By virtue of the invention, a second switch is used which makes it possible to precharge the capacitor before the first switch used to power the electronic power-supply circuit of the electric machine closes. This second switch makes it possible to clearly separate the precharge function of the capacitor from the power supply of the electronic power-supply circuit. Therefore, the precharge circuit is outside the power circuit and does not introduce any additional impedance which would cause a loss of efficiency and EMC problems.

Moreover, the second switch is used only to precharge the capacitor and is not used for supplying the electronic circuit; consequently, it is quite possible to employ a switch operating at low power and having a resistance in the on state that is higher than that of the transistors used in the aforementioned known solutions.

For this purpose, said precharge circuit and said second switch are mounted, for example, in series between the terminals of said first switch.

The system according to the invention may also have one or more of the features below, considered individually or in all the technically possible combinations:
said voltage source is the battery of a motor vehicle.
said second switch is formed by the after-ignition power-supply device.
said at least one capacitor is an electrochemical capacitor.
said precharge circuit comprises a transistor, the control of said transistor ensuring the precharging of said capacitor.
said transistor is controlled to open before the closure of said first switch.
said precharge circuit comprises a resistor in parallel with a transistor.
the system according to the invention comprises a second capacitor mounted in parallel on said first capacitor.
said electronic power-supply circuit is a circuit for supplying power to an electric motor.
said electronic power-supply circuit is formed by a power-supply chopping circuit.
said system comprises means for controlling said first switch to close after the precharging of said capacitor.

The invention also relates to the use of said system, as evoked above, in which said first switch is controlled to close after the precharging of said capacitor.

Other features and advantages of the invention will clearly emerge from the description given thereof below, as an indication and in no way limiting, with reference to the appended figures, amongst which:

FIG. 1 is a simplified schematic representation of a first system for supplying power to an electric machine according to the prior art;

FIG. 2 is a simplified schematic representation of a second system for supplying power to an electric machine according to the prior art;

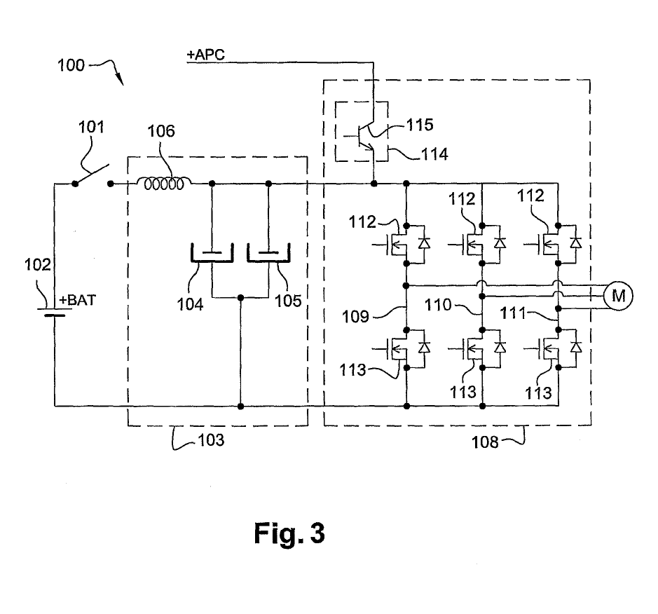

FIG. 3 is a simplified schematic representation of a system for supplying power to an electric machine according to the invention.

FIGS. 1 and 2 are described above with reference to the prior art.

FIG. 3 is a simplified schematic representation of a system 100 according to the invention.

The system 100 comprises:
a voltage source 102 formed by the battery of the vehicle,
a power circuit 103,
an electronic power-supply circuit 108 designed to supply power to a motor M.

The power circuit 103 comprises:
a switch 101 such as an electromechanical relay making it possible to selectively connect the battery 102 to the power circuit 103 and to the electronic power-supply circuit 108,
two electrochemical capacitors 104 and 105 mounted in parallel,
an inductor 106 connected between the positive terminal +Bat of the battery 102 and the common positive terminal of the two electrochemical capacitors 4 and 5.

The function of the power circuit 103 is to transmit the voltage from the battery 102 to the electronic power-supply circuit 108. The power circuit consists, for example, of several copper busbars, not shown.

In the case of a three-phase brushless motor M such as that typically used in an electric power steering system, the electronic power-supply circuit 108 is usually formed by an electronic circuit board of the IMS (Insulated Metal Substrate) type consisting of a chopping power-supply circuit comprising three bridge arms 109, 110 and 111 each comprising two transistors 112 and 113 mounted in series, each transistor being furnished with an antiparallel diode (the antiparallel diode is often present by manufacture on field-effect transistors of the MOSFET type). Each of the three stator windings of the motor M is therefore powered by one of the bridges 109, 110 and 111. For the purposes of clarity, the circuits for controlling the transistors have not been shown.

The electronic power-supply circuit 108 also comprises a precharge circuit 114 formed, for example, by a two-pole transistor 115 (the presence of the relay 101 requires the presence of the precharge circuit 114 for precharging the capacitors 104 and 105 in order to prevent too powerful inrush currents. This two-pole transistor is connected between the positive terminal of the electrochemical capacitors 104 and 105 and the after-ignition power-supply device +APC of the vehicle. When the vehicle ignition is activated, the +APC of the vehicle sends a power-supply signal making it possible to switch certain electronic systems of the vehicle from their standby or off state to their nominal awake state. The after-ignition +APC makes it possible to connect the transistor 115 to the voltage source of the battery 102.

The filter formed by the inductor 106 and the electro-chemical capacitors 104 and 105 is designed to stabilize the voltage of the battery 102 which may sustain chopping caused by the electronic circuit 108. The value of the filtering capacity is usually high, that is why two discrete electrochemical capacitors 104 and 105 mounted in parallel are used. As an example, the capacity value of each of the electrochemical capacitors 104 and 105 in an application of this type is of the order of 3300 μF with a 0.6 μH inductor 106.

The +APC signal and the relay 101 are for example controlled by the onboard computer.

The operation of the system 100 is as follows: after the +APC ignition is switched on (connection of the battery voltage via the ignition key which actuates a relay), the control electronics, not shown, controls the closure of the precharge transistor 115 (for example via increasingly frequent pulses) so that the capacitors 104 and 105 are charged progressively. Once the capacitors 104 and 105 are charged, the control electronics, not shown, controls the opening of the precharge transistor 115 and then the onboard computer controls the closure of the relay 101 thus allowing the power circuits 103 and 108 to be powered by the battery 102. The time, imposed by the onboard computer, separating the +APC and the closure of the relay 101 must be sufficient to allow a correct precharging of the capacitors 104 and 105.

By virtue of the system 100 according to the invention, the precharge circuit does not come between the battery 102 and the motor M affecting the electrical efficiency. All of the voltage delivered by the battery goes directly into the electronic circuit 108 via the power circuit 103 designed to exhibit a minimum of losses (the use of a copper busbar with few ohmic losses).

Moreover, the two-pole transistor 115 used in the precharge circuit 114 is used only to precharge the capacitors and may therefore be a transistor having performance (notably in terms of impedance in the on state) that is lower (and therefore having lower cost) than the power transistors used in the known precharge circuits.

Finally, the precharge circuit 114 belongs to the electronic circuit board 108 and not to the power circuit 103 so that the precharge circuit does not change the structure of the power circuit 103 and has no impact in terms of EMC on the power circuit 103.

Naturally, the invention is not limited to the embodiment that has just been described.

Notably, a precharge circuit consisting of a two-pole transistor has been described as an illustration. It is however possible to use any type of transistor such as a field-effect transistor for example.

Moreover, the precharge circuit may also be formed by a transistor in parallel on a resistor.

Finally, it is possible to replace any means by an equivalent means.

1. A system for supplying power to an electric machine comprising:
a voltage source;
an electronic circuit for supplying power to said electric machine;
a first switch, wherein the voltage source supplies power to said electronic circuit when said first switch is in the closed position;
at least one capacitor mounted in parallel on said voltage source when said first switch is in the closed position;
a circuit for precharging said capacitor; and
a second switch, wherein the precharge circuit is connected to said voltage source when said second switch is closed, and wherein said first switch is controlled to close after the precharging of said at least one capacitor.

2. The power-supply system as claimed in claim 1, wherein said voltage source is a battery of a motor vehicle.

3. The power-supply system as claimed in claim 1, wherein said second switch is formed by an after-ignition power-supply device.

4. The power-supply system as claimed in claim 1, wherein said at least one capacitor is an electrochemical capacitor.

5. The power-supply system as claimed in claim 1, wherein said precharge circuit comprises a transistor, the control of said transistor ensuring the precharging of said at least one capacitor.

6. The power-supply system as claimed in claim 5, wherein said transistor is controlled to open before the closure of said first switch.

7. The power-supply system as claimed in claim 1, wherein said precharge circuit comprises a resistor in parallel with a transistor.

8. The power-supply system as claimed in claim 1, wherein the at least one capacitor comprises a second capacitor mounted in parallel to a first capacitor.

9. The power-supply system as claimed in claim 1, wherein said electronic circuit is a circuit for supplying power to an electric motor.

10. The power-supply system as claimed in claim 1, wherein said electronic circuit is formed by a power-supply chopping circuit.

11. The power-supply system as claimed in claim 1, further comprising means for controlling said first switch to close after the precharging of said at least one capacitor.

12. (canceled)
